(19) United States
(12) Patent Application Publication
(10) Pub. No.: US 2021/0350575 A1
(43) Pub. Date: Nov. 11, 2021

(54) THREE-DIMENSIONAL CAMERA POSE DETERMINATION

(71) Applicant: Hewlett-Packard Development Company, L.P., Spring, TX (US)

(72) Inventors: Yun David Tang, Spring, TX (US); Vijaykumar Nayak, San Diego, CA (US); Shaymus Alwan, Vancouver, WA (US); Javier Urquizu, San Diego, CA (US); Yow Wei Cheng, Taipei City (TW); Andy Yi-Chih Liao, San Diego, CA (US)

(73) Assignee: Hewlett-Packard Development Company, L.P., Spring, TX (US)

(21) Appl. No.: 17/264,341

(22) PCT Filed: Feb. 1, 2019
(86) PCT No.: PCT/US2019/016424

§ 371 Date: Jan. 29, 2021

(51) Int. Cl. G06T 7/80; G06T 7/73; H04N 13/296; H04N 13/246

(52) U.S. Cl. CPC G06T 7/85; G06T 7/73; G06T 2207/30244; H04N 13/246; G06T 2207/30204; H04N 13/296

(57) ABSTRACT

An example system includes a plurality of cameras to capture images of a target object and a controller to connect to the plurality of cameras. The controller is to control the plurality of cameras to capture the images of the target object. The controller is further to determine a pose of a camera of the plurality of cameras. The system further includes a platform to support the target object. The platform includes a plurality of unique markers arranged in a predetermined layout. The controller is further to determine the pose of the camera based on unique markers of the plurality of unique markers that are detected in an image captured by the camera.

### BACKGROUND

Three-dimensional (3D) object scanning is the process of collecting data that describes the shape of a real-world object. Collected data may be used to construct digital 3D models. A 3D scanner may be used to collect such data. Various kinds of 3D scanners are known, such as multi-camera systems that capture image and depth information, single-camera systems that scan a rotating object, and similar.

### BRIEF DESCRIPTION OF THE DRAWINGS

FIG. 1 is a schematic diagram of an example system to determine a pose of a camera based on unique markers on a platform.

FIG. 2 is a flowchart of an example method to generate a calibration for a camera based on a pose of the camera determined from unique markers on a platform.

FIG. 3 is a schematic diagram of an example calibration of a camera based on unique markers on a platform.

FIG. 4 is a flowchart of an example method to generate a calibration for a camera based on a pose of the camera determined from unique markers on a platform, where detected unique markers may be ranked.

FIG. 5 is a flowchart of an example method to generate a calibration for a camera based on a pose of the camera determined from unique markers on a platform, where user-interface feedback may be generated.

FIG. 6 is a flowchart of an example method to generate and validate a calibration for cameras based on poses of the cameras determined from unique markers.

FIG. 7 is a flowchart of an example method of validating a calibration for cameras based on poses of the cameras determined from unique markers.

FIG. 8 is a flowchart of an example method of performing a depth-based check on a calibration for cameras based on poses of the cameras determined from unique markers.

FIG. 9 is a schematic diagram of an example system to determine a pose of a camera based on unique markers on a platform, where the camera is connected with respect to the platform by an arm.

FIGS. 10A to 10C are schematic diagrams of example layouts for unique markers.

FIGS. 11A and 11B are schematic diagrams of example cameras capturing example marker shapes.

### DETAILED DESCRIPTION

A 3D scanner may use a calibration to account for varied positioning and orientation of a camera relative to an object to be scanned. One such calibration technique uses a separate physical 3D target of known shape and dimensions. The object is scanned in 3D to generate a calibration. Another such technique uses a target having a known pattern, such as a checkerboard pattern, that is moved within a camera's field of view. Both of these techniques have drawbacks. A separate calibration object adds complexity to a system and may be misplaced. A moving target adds complexity by way of a mechanical movement mechanism. Further, both techniques suffer in that they may not be readily configurable for a particular use case.

In addition, environmental factors, such as lighting and occlusion, may complicate known calibration techniques.

A system that addresses these problems, includes a platform on or above which a target object to be scanned may be placed. The system includes multiple cameras to generate 3D shape data of the object. The pose of each camera may be calibrated so that the 3D shape data of the target object is accurate.

The platform has a surface that includes markers to calibrate the cameras. The markers are relatively unique and are located at known positions on the platform. Each camera may capture an image that includes any number of markers. An image from a camera may be used to determine the pose of that camera.

The platform may remain stationary during calibration and target object capture. Calibration may be performed prior to scanning of the target object scanning or during such scanning.

A quantity of markers may be used so that occlusion of a particular marker does not significantly affect the calibration. Imaging quality of the markers may be determined and used to disregard poorly resolved markers or rank markers for use in a calibration.

A calibration may be staged, in that detected marker quantity and quality evaluated before pose determination. A user alert or other feedback may be raised if marker quantity or quality does not meet criteria to perform pose determination. As such, the user need only intervene in extreme cases of low lighting, image saturation, occlusion, etc.

The system does not use a separate physical 3D target nor a moving calibration target. Layout of the markers is flexible and may be tailored to different use cases, which may allow for flexibility in camera positioning. The calibration is robust in the sense that occluded markers or markers of low imaging quality may be disregarded.

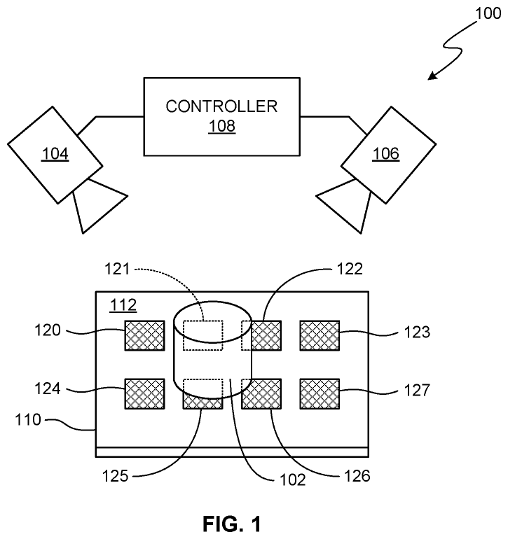

FIG. 1 shows an example system 100. The system 100 captures images and depth information that may be used to generate 3D data of a target object 102. The system 100 may be referred to as a 3D scanner.

The system 100 includes a plurality of cameras 104, 106, a controller 108, and a platform 110. The system 100 may be assembled and disassembled. When disassembled, the components 104-110 of the system 100 may be stored and/or transported together. When assembled, the components 104-110 may be affixed relative to one another and generally stationary.

The target object 102 may be placed on or above the platform, so that the target object 102 is partially or fully located within the fields of view of the cameras 104, 106.

The cameras 104, 106 may be arranged to have a surrounding view of the target object 102 on the platform 110. The cameras 104, 106 may be positioned and oriented so that their fields of view overlap. Any practical number of cameras and/or depth sensors may be used, such as three, four, etc.

A camera 104, 106 may capture visible light, infrared light, or both to obtain images of the target object 102. A camera 104, 106 may include or operate in conjunction with a depth sensor that uses stereo visible light, stereo infrared light, structured light, time-of-flight, or similar to generate a depth map (or depth image) according to a world coordinate system. Two-dimensional images and depth information may be related to each other by a predetermine relationship, which may be established during a pre-calibration at time of manufacture or factory testing of the system 100. A camera 104, 106 may have intrinsic properties, such as focal length and principle point location, and an extrinsic transformation that describes a position and orientation of the camera 104, 106 in the world coordinate system. A depth sensor may be pre-calibrated, with intrinsic properties of a camera, such focal length (e.g., fx, fy) and principle point location (e.g., cx, cy), and an extrinsic transformation between infrared and depth or an extrinsic transformation between color and depth. A depth-relative translation and orientation may be pre-calculated and stored in the camera.

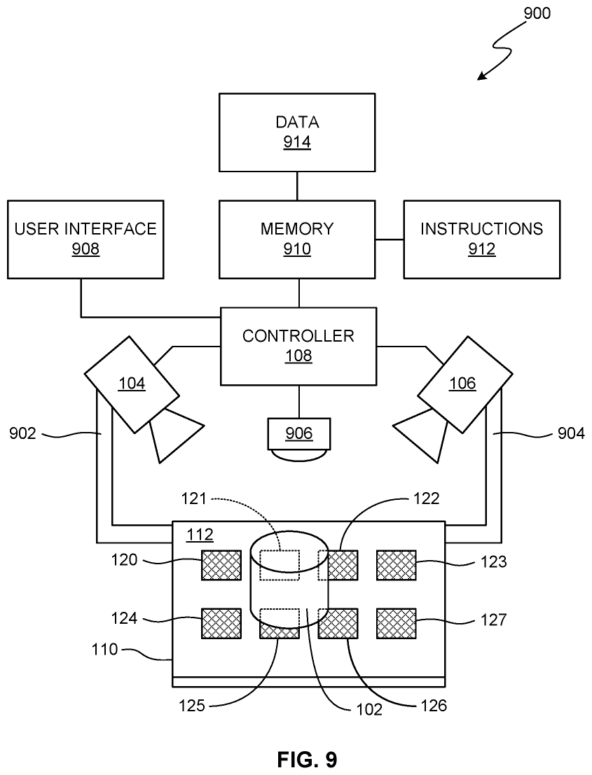

Depth information of the target object 102, whether captured by the cameras 104, 106, if capable, or by a separate depth sensor (see FIG. 9), may be used to determine 3D data of the target object 102.

The controller 108 may be connected to the cameras 104, 106 to control the cameras 104, 106 to capture images of the target object 102. The controller 108 determines a pose of a camera 104, 106. The poses may be referenced to align and merge 3D data of the target object 102. The controller 108 may align and merge such 3D data or may provide the poses to another set of instructions, controller, or device that aligns and merges such 3D data.

The controller 108 may perform a calibration for the extrinsic transformation of the cameras 104, 106, so that multiple slices of data of the target object 102 collected from the different positions and orientations of the cameras 104, 106 may be aligned and merged into a 3D model of the target object 102. A camera's extrinsic transformation, otherwise known as the camera's pose, is described by six degrees-of-freedom, such as the camera's coordinates in 3D space (e.g., Tx, Ty, Tz) and the camera's orientation (e.g., Rx, Ry, Rz) relative to an origin or datum in a world coordinate system. A camera's pose may be determined and used in a calibration to compute aligned 3D data of the target object 102. The calibration may be referred to as a field calibration, that is, a calibration that is performed after the system 100 is assembled and during operation of the system 100.

The controller 108 may include a central processing unit (CPU), a microcontroller, a microprocessor, a processing core, a field-programmable gate array (FPGA), an application-specific integrated circuit (ASIC), or a similar device capable of executing instructions. The controller 108 may cooperate with a non-transitory machine-readable medium that may be an electronic, magnetic, optical, or other physical storage device that encodes executable instructions. The machine-readable medium may include, for example, random access memory (RAM), read-only memory (ROM), electrically-erasable programmable read-only memory (EEPROM), flash memory, a storage drive, an optical device, or similar.

The platform 110 supports the target object 102. The platform 110 may be planar, such as a flat plate, and may have a top surface 112 that is generally exposed to the fields of view of the cameras 104, 106. The platform 110 may be rectangular, circular, or have another shape. The target object 102 may be placed directly on the platform 110 or may be held above the platform by a support that sits on or near the platform 110.

The platform 110 includes a plurality of unique markers 120-127 arranged in a predetermined layout. A unique marker 120-127 may be referred to as fiducial. The unique markers 120-127 may be located at the top surface 112 of the platform 110. The unique markers 120-127 may be stickers adhered to the platform 110, printed to a medium that is placed or affixed on the platform 110, etched/embossed into the platform 110, printed directly onto the platform 110, molded into the platform 110, or provided in a similar manner. The unique markers 120-127 are to remain at static locations relative to one another. For example, a unique marker 120-127 may be located at a 3D position (e.g., x, y, z) relative to a world origin coordinate (e.g., 0, 0, 0). When the platform 110 is planar, one component of the coordinates (i.e., x, y, or z) of the unique markers 120-127 is the same.

The markers 120-127 on the platform 110 are relatively unique. In this example, each marker 120-127 is distinguishable from each other marker. For example, a marker 120-127 may include areas of contrast that are decodable by the controller 108 into a unique numeric or alphanumeric code (e.g., 1001). A marker 120-127 may be in the shape of a square, rectangle, circle, donut, line pattern, or similar pattern of contrasting areas. Examples of suitable markers 120-127 include ArUco markers, 2D barcodes (e.g., Quick Response or QR codes), or similar. Unique markers 120-127 of one platform 110 may be the same as unique markers 120-127 of another platform 110.

The predetermined layout of the unique markers 120-127 is provided to the controller 108, so that the controller 108 has knowledge of the predetermined layout. The particular layout used in a given implementation of the platform 110 may be selected based on nominal poses of the plurality of cameras 104, 106 and the use case of the system 100. The quantity of markers 120-127 used may be selected based on nominal poses of the plurality of cameras 104, 106 and the use case of the system 100. The quantity of unique markers 120-127 may be greater than a minimum number to determine the actual poses of the cameras 104, 106.

A nominal camera pose may be a pose expected when the system 100 is in use. Nominal camera poses may be chosen based on specific use cases, such as the type of target object to be scanned, lighting constrained, potential obstructions in a camera's field of view, and the like. An actual pose may differ from a nominal pose due to various reasons, such as inaccurate setup of the system 100, movement of the cameras 104, 106 and/or platform 110 over time, vibrations in the building that houses the system 100, and so on.

The controller 108 determines the actual pose of a camera 104, 106 based on unique markers 120-127 that are detected in an image captured by the camera 104, 106. The controller 108 may determine the pose of each camera 104, 106 with reference to a respective image captured by each camera 104, 106. Pose information of a camera 104, 106 may be used to align and merge 3D data of the target object 102 from depth information and 2D images in which the target object 102 is present. An image captured to determine a camera pose may also be used to capture the target object 102. That is, the calibration may be performed after the target object 102 is placed on the platform 110 and using the same images.

For example, with reference to the example of FIG. 1, the camera 104 may capture an image in which unique markers 120, 123, 124, 127 are completely resolved. The controller 108 may then decode these unique markers 120, 123, 124, 127 and reference the predetermined layout of the unique markers 120-127 to compute the pose of the camera 104. The unique markers 121, 122, 125, 126 may be partially or completely obscured by the target object 102. A unique marker 121 may be completely hidden and thus not detectable. A unique marker 122, 125, 126 may be partially apparent in the captured image, but may have poor imaging quality (e.g., low contrast ratio, in a shadow cast by the target object, etc.) or may be undecodable. Hence, the unique markers 121, 122, 125, 126 may be disregarded by the controller 108 when determining the pose of the camera 104.

The same may apply to another camera 106 whose pose is to be computed. For example, the camera 106 may capture an image in which the unique markers 120, 123, 124, 127 are completely resolved. The unique markers 121, 125 may be too obstructed by the target object 102 or have too low imaging quality to use. The unique markers 122, 126 may be partially obstructed by the target object 102 but may still be resolvable into respective unique codes and may have sufficient imaging quality.

The predetermined layout and quantity of unique markers 120-127 used may be selected so that various positions of expected target objects 102 on the platform 110 leave a sufficient number of markers 120-127 exposed to the field of view of a camera 104, 106 whose pose is to be computed. The predetermined layout and quantity of unique markers 120-127 may thus have redundancy that reduces the need for human intervention to position a target object 102. For example, a predetermined layout and quantity of unique markers 120-127 may be selected so that a particular target object 102 may be placed anywhere on the platform 110 and still leave a sufficient number of markers 120-127 exposed.

The predetermined layout and quantity of unique markers are readily configurable for specific use cases. For example, a particular pattern of unique markers may be provided to a platform 110 for a system 100 that is to scan a particular class of target objects. In another example, a particular pattern of unique markers may be printed to a medium, such as paper, and placed on top of a generic platform 110.

A pose of a camera 104, 106 may be stored by the controller 108 for use in a calibration. The calibration may be applied to images of a target object 102 obtain accurate 3D data for the target object 102, so that the target object 102 may be modelled accurately.

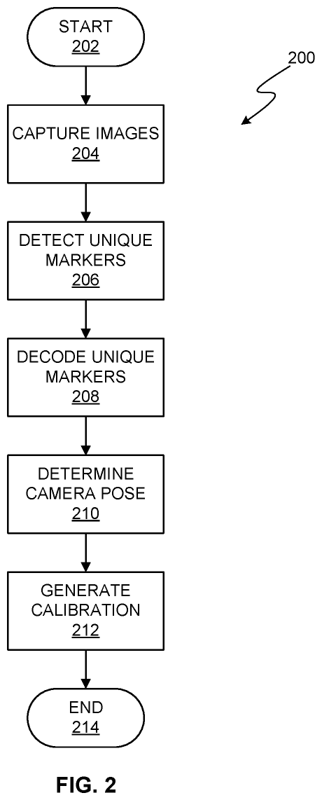

FIG. 2 shows an example method 200 of calibrating a 3D camera system. The method 200 may be performed with any of the devices and systems described herein. The method 200 may be embodied by a set of controller-executable instructions that may be stored in a non-transitory machine-readable medium. The method begins at block 202.

At block 204, a plurality of cameras captures images of a scene. The scene includes a platform having unique markers disposed on a surface thereof. A target object may be situated on or above the platform. The images may include 2D images of the scene, images with depth information, depth maps, and similar.

At block 206, unique markers are detected in captured images. Image pre-processing, such as applying a bilateral filter, may be performed to suppress noise in the image to aid marker detection.

A unique marker may be disregarded if the unique marker appears in the image with imaging quality that fails to meet a minimum quality. This may occur under low or poor-quality environmental light. Further, a unique marker may be hidden or obscured by the target object or may be subject to other condition that renders the unique marker obscured or undecodable.

At block 208, detected unique markers are decoded. For example, a predetermined decoding scheme may be referenced to convert areas of contrast (e.g., bright and dim patches) arranged in a detectable pattern to a unique code. Feature detection and perspective correction may be used for marker detection and/or decoding.

Detecting and decoding the unique markers, at blocks 206 and 208, may be performed at approximately the same time and/or by the same process. The separation of blocks 206 and 208 is merely for sake of explanation.

At block 210, a pose of a camera is computed. A predetermined layout of the unique markers may be referenced to obtain a pose of a camera that captured a particular image. That is, a unique marker may be decodable into a code that may be associated with coordinates relative to world coordinate system origin, such as the coordinates of a particular unique marker, a corner of the platform, the center of the platform, or similar. Hence, the measured coordinates of a unique marker in an image may be associated with the actual coordinates of a unique marker in the real world. Hence, the coordinates of multiple unique markers captured by a particular camera may be resolved into an actual pose of the camera. Multiple cameras may have respective poses computed.

At block 212, a calibration may be generated with reference to a computed camera pose, and further may be generated with reference to relative poses between cameras, and homography information of detected markers (e.g., a relation between 2D image coordinates and 3D world coordinates). The calibration may map 2D image coordinates captured by the camera and depth information to 3D world coordinates. The calibration may be referenced when generating 3D data of the target object from captured 2D images and depth information. A calibration may be generated for multiple cameras based on respective poses.

The method 200 ends at block 214. The method 200 may be repeated continuously, regularly, or periodically while a system is in operation. The method 200 may be performed without a target object located on the platform. The method 200 may be performed with a target object located on the platform and redundancy in placement and/or number of unique markers may provide sufficient robustness to generate the calibration when fewer than all unique markers are detected and decoded.

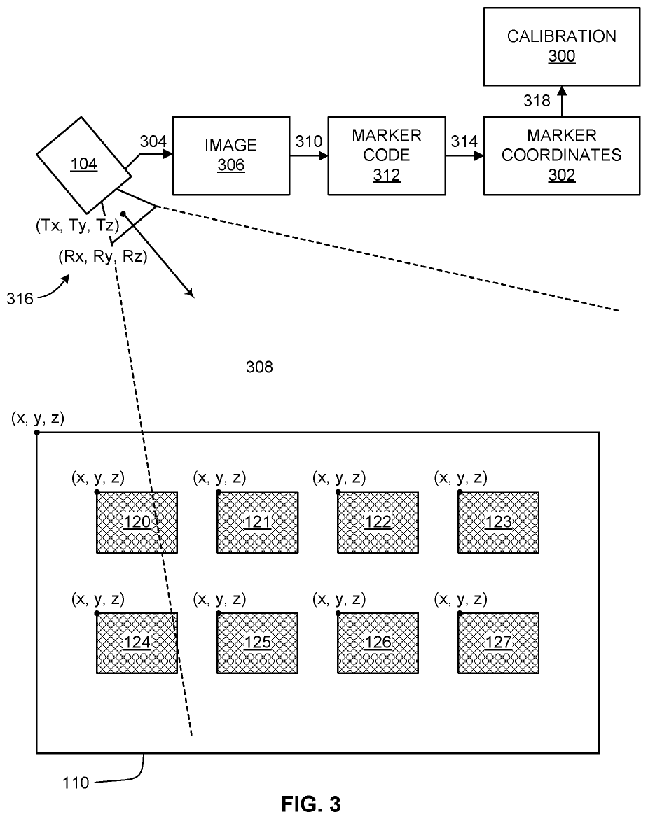

FIG. 3 shows an example calibration computed from a captured image containing unique markers. Although one camera 104 is shown for sake of explanation, the description below applies to any number of cameras 104, 106 operating in conjunction.

A plurality of unique markers 120-127 is provided in a predetermined 2D layout to a platform 110, which is to support a target object. Each unique marker 120-127 may be assigned coordinates (e.g., x, y, z) in a world coordinate system, which may correspond to the real world. The coordinates of a unique marker 120-127 may represent the corner of the unique marker 120-127, the center of the unique marker 120-127, or a similar point. The world coordinate system may have an origin at any point, such as the coordinates of particular unique marker 120-127, the coordinates of the platform 110 (e.g., at a corner or center), or other datum point.

A camera 104 may capture 304 an image 306 in its field of view 308. Unique markers 120-127 that may be satisfactorily resolved in the image 306 may be decoded 310 to obtain corresponding marker codes 312.

Marker codes 312 may be associated with marker coordinates 302. Hence, the coordinates of detected and decoded unique markers 120-127 may be obtained 314. Marker coordinates 302 determined for a sufficient number (e.g., three, four, five, etc.) of unique markers 120-127 may be used to compute a pose 316 of the camera 104. The calibration 300 for the camera 104 may thus be generated 318. Nomography information of the detected and decoded unique markers 120-127 may also be stored as part of the calibration 300.

When computing a pose for a camera with known intrinsic properties using a rigid body pose transformation, three detected unique markers 120-127 may be used. Three markers have three pairs of 2D image positions in an image and corresponding 3D points in world coordinates. Using a greater number of detected unique markers 120-127, such as five, may increase accuracy, particularly when camera lens distortion is a concern and/or when there is an uncontrolled/unpredictable ambient environment.

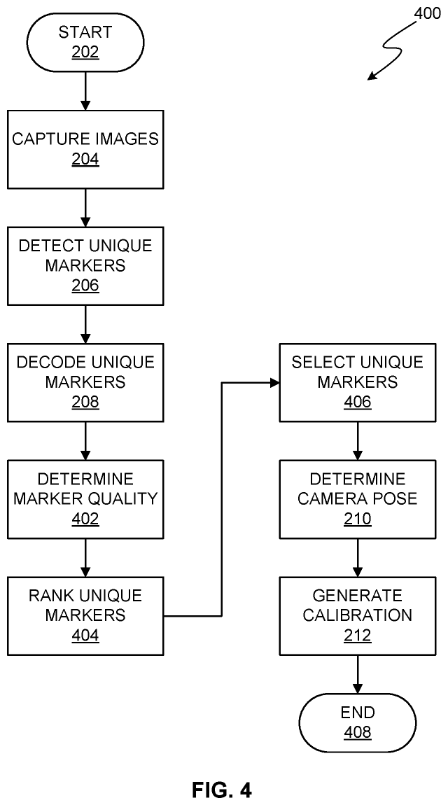

FIG. 4 shows an example method 400 of calibrating a 3D camera system. The method 400 may be performed with any of the devices and systems described herein. The method 400 may be embodied by a set of controller-executable instructions that may be stored in a non-transitory machine-readable medium. For blocks not described in detail here, the other methods described herein may be referenced, with like numerals denoting like blocks. The method begins at block 402.

At block 204, a plurality of cameras captures images of a scene. The method 400 may be performed for the plurality of cameras.

Unique markers, which are present on a platform, may be detected in the image, at block 206.

The unique markers may be decoded, at block 208.

The imaging quality of regions of the images that contain the unique markers may be determined, at block 402. Examples of marker-related imaging quality factors include the apparent size of the marker in the image, sharpness, contrast ratio between marker and background, reprojection error, brightness, and so on. Multiple factors may be weighted and combined. For example, a number of marker-related imaging quality factors may be assigned weightings and a weighted marker quality score may be computed for each marker. The unique markers may then be ranked by quality score, at block 404.

At block 406, a suitable quantity of the highest ranked unique markers may be selected to obtain camera pose. Unselected markers may be disregarded for purposes of obtaining camera pose.

Then, a pose of a camera may be computed, at block 210, and a calibration may be generated, at block 212.

The method 400 ends at block 408. The method 400 may be repeated continuously, regularly, or periodically while a system is in operation. The method 400 may be performed without a target object located on the platform. The method 400 may be performed with a target object located on the platform and redundancy in placement and/or number of unique markers may provide sufficient robustness to generate the calibration when fewer than all unique markers are detected and decoded.

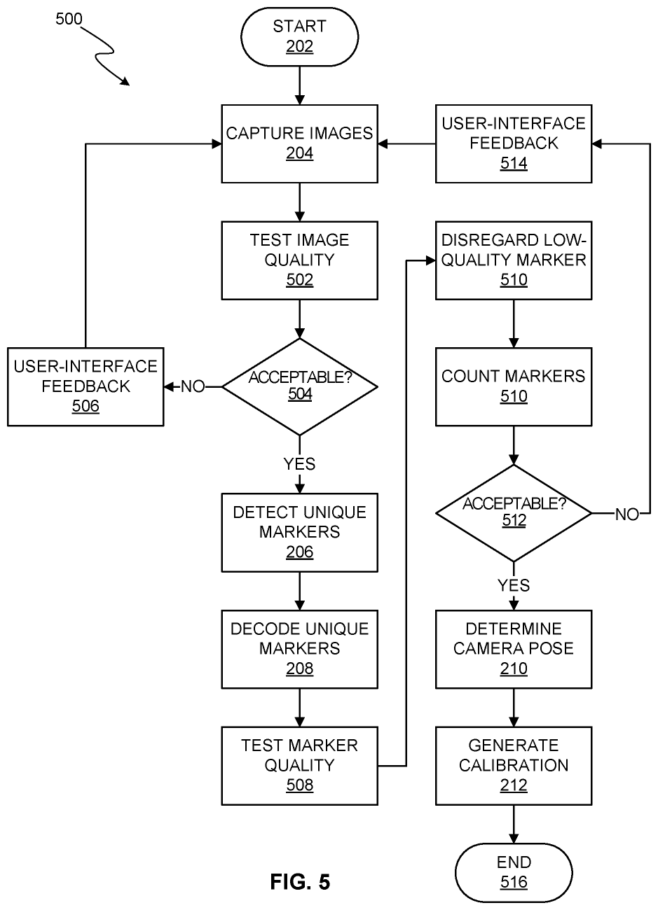

FIG. 5 shows an example method 500 of calibrating a 3D camera system. The method 500 may be performed with any of the devices and systems described herein. The method 500 may be embodied by a set of controller-executable instructions that may be stored in a non-transitory machine-readable medium. For blocks not described in detail here, the other methods described herein may be referenced, with like numerals denoting like blocks. The method begins at block 502.

At block 204, a plurality of cameras captures images of a scene. The method 500 may be performed for the plurality of cameras.

At block 502, an imaging quality of a captured image may be tested to determine whether the image meets a minimum imaging quality, which may be taken as a condition to determine a pose of the camera that captured the image. A low-quality image may be omitted from use in determining camera pose, so as to reduce error.

Imaging quality of an image may be due to the lighting environment around a system. Examples of imaging quality factors include contrast, brightness, saturation, and so on. An individual factor may be determinative (e.g., contrast too low) or several factors may be weighted and combined. If the image fails to meet a minimum imaging quality, at block 504, user-interface feedback may be triggered, at block 506, to generate a user-interface alert to indicate remedial user action that may be taken to improve imaging quality, such as turning on ambient lights. The method 500 may then return to block 204 and repeat.

If the image meets a minimum imaging quality, at block 504, then unique markers, which are present on a platform, may be detected in the image, at block 206, and decoded, at block 208.

The imaging quality of regions of the images that contain the unique markers may be tested, at block 508. Examples of marker-related imaging quality factors are given above. An individual factor may be determinative (e.g., contrast ratio too low) or factors may be weighted and combined. A unique marker that fails to meet a minimum imaging quality may be disregarded, at block 510, for purposes of determining camera pose.

At block 510, unique markers detected in the image may be counted. At block 512, the count may be tested to determine whether a minimum number of unique markers has been met. A threshold number of unique markers may be taken as a condition to determine a pose of a camera. A quantity of detected unique markers that does not meet the threshold number, at block 512, may determine that remedial user action for an unresolved unique marker is to be performed. In such case, user-interface feedback, such as an alert, may be triggered, at block 514.

The user-interface feedback, at block 514, may indicate remedial user action that may be taken to reduce possible occlusion or obstruction of a unique marker, such as moving a person or object out of a camera's field of view, or to improve imaging quality of a unique marker, such as turning on ambient lights. The method 500 may then return to block 204 and repeat.

When a minimum number of unique markers has been detected and decoded, then a pose of a camera may be computed, at block 210, and a calibration may be generated, at block 212.

The method 500 ends at block 516. The method 500 may be repeated continuously, regularly, or periodically while a system is in operation. The method 500 may be performed without a target object located on the platform. The method 500 may be performed with a target object located on the platform and redundancy in placement and/or number of unique markers may provide sufficient robustness to generate the calibration when fewer than all unique markers are detected and decoded.

Regarding blocks 508 and 510, in addition to or as an alternative to discarding low-quality unique markers, detected unique markers may be scored and ranked based on imaging quality. Then, a suitable quantity of the highest ranked unique markers may be selected to obtain camera pose. The score of a unique marker may be computed based on an imaging factor or combination of imaging factors, examples of which are given above.

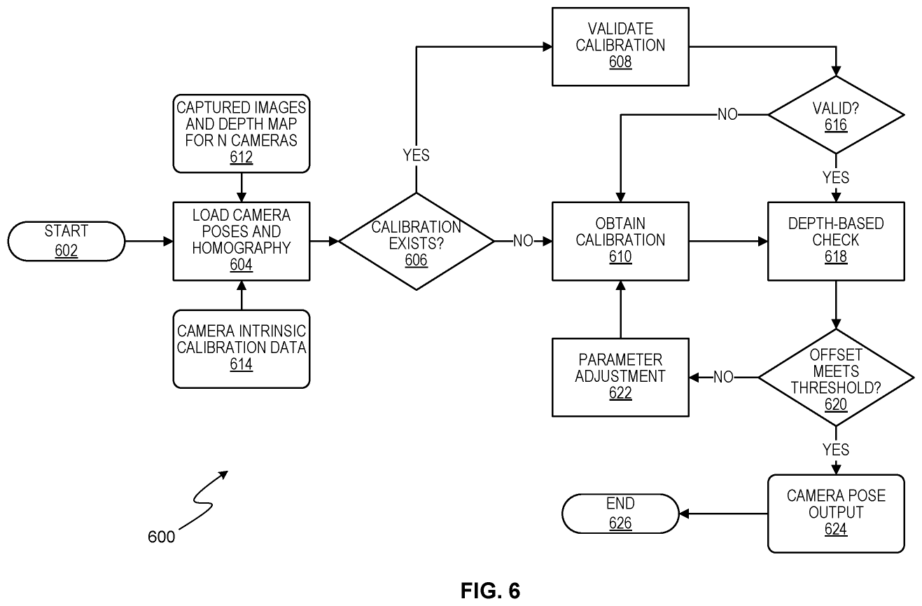

FIG. 6 shows an example method 600 of calibrating cameras and validating the calibration. The method 600 may be performed with any of the devices and systems described herein. The method 600 may be embodied by a set of controller-executable instructions that may be stored in a non-transitory machine-readable medium. The method begins at block 602.

At block 604, poses and marker homography information of a plurality of cameras may be loaded, if available. The camera poses and marker homography information, or representations thereof, may be considered a calibration for a 3D imaging system.

Via block 606, if the calibration exists, then the existing calibration may be validated, at block 608. If the calibration does not exist, then a new calibration may be obtained, at block 610. Captured 2D images and captured depth information 612 may be used for validation and obtaining a new calibration. Further, intrinsic calibration data 614 of the cameras, such as data regarding focal length and principle point location, may also be used.

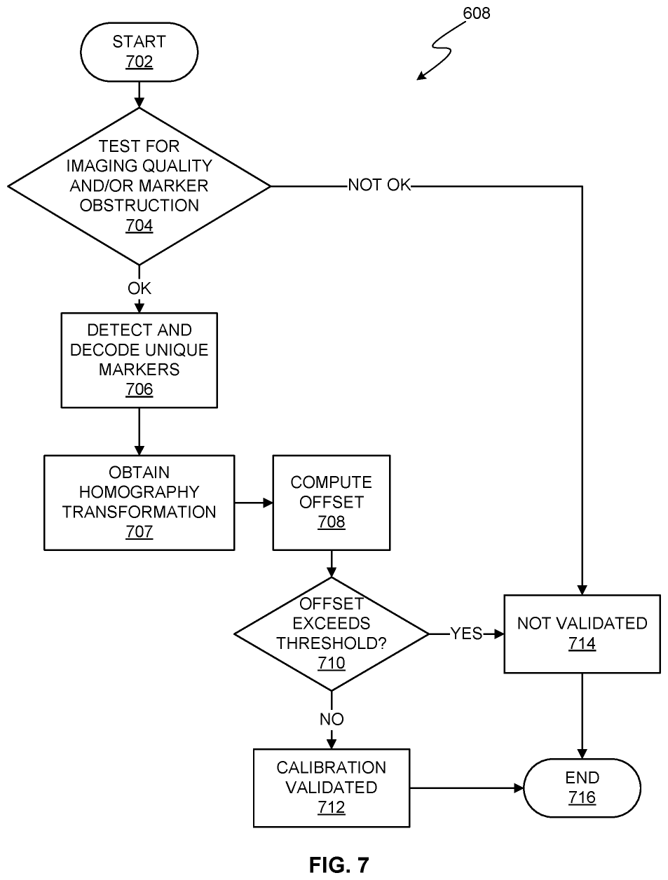

At block 608, validation of an existing calibration may include detecting and decoding unique markers in images captured by the cameras and computing 3D positions of the unique markers in a world coordinate system. The computed positions of unique markers and the marker homography information may be used to validate the current calibration, as will be further described with respect to FIG. 7. If the computed positions of the unique markers are sufficiently accurate, at block 616, then the existing calibration is validated. If the existing calibration is not validated, then a new calibration is obtained, at block 610.

At block 610, obtaining a new calibration may include imaging quality determination, unique marker detection and decoding, marker selection and/or disregarding, and computation of camera poses, as described with respect to the various methods of FIGS. 2 to 5. Any of these methods or combinations thereof may be used.

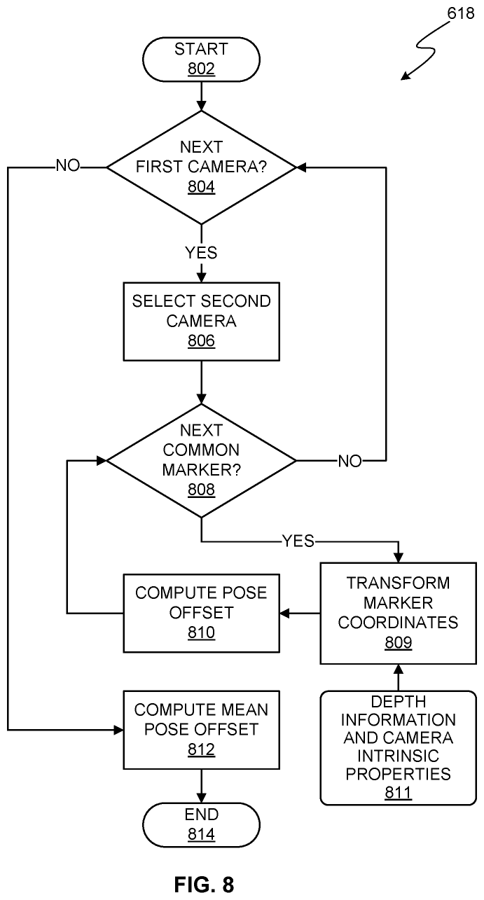

Then, at block 618, a depth-based check is performed on a validated or new calibration. The depth-based check may determine a pose offset between a camera and another camera of the system. Pose offsets for multiple different pairings of cameras may be computed. Pose offsets for all camera pairings may be computed. A pose offset may be checked individually or in combination with other pose offsets, such as by computing a mean pose offset. An example depth-based check will be described in further detail with respect to FIG. 8

If the pose offset fails to meet an acceptable threshold (e.g., the offset is greater than the threshold), at block 620, then a new calibration is again obtained, at 610, to redetermine the poses of the of cameras. Prior to obtaining the new calibration after failure of the depth check, a parameter may be adjusted, at block 622. Examples of parameter adjustments including applying a filter to captured image or set of images, adjusting a camera setting and recapturing an image, issuing feedback to a user to change a lighting condition or check for obstructions, and the like.

If the offset meets the acceptable threshold, at block 620, then the computed camera poses may be used for a new calibration, at block 624.

The method 600 ends at block 626. The method 600 may be repeated continuously, regularly, or periodically while a system is in operation. The method 600 may be performed without a target object located on the platform. The method 600 may be performed with a target object located on the platform and redundancy in placement and/or number of unique markers may provide sufficient robustness to generate the calibration when fewer than all unique markers are detected and decoded.

FIG. 7 shows an example of a method of calibration validation that may be used at block 608 in the method 600 of FIG. 6. The method starts at block 702 and may reference an existing calibration to be validated and newly captured images and depth information (ref. 612 in FIG. 6).

At block 704, captured images may be subject to an imaging quality test and/or a test for marker obstruction (e.g., insufficient number of unique markers in an image). Examples of these techniques are given above. If the imaging quality and/or marker obstruction is not sufficient to proceed, then the existing calibration is determined to not be validated, at block 714

At block 706, unique markers are detected in the captured images and decoded. Examples of this are given above. Decoding of a unique marker may determine the marker's world coordinates (e.g., x, y, z) based on a predetermined layout of unique markers.

At block 707, a homography transformation to map image coordinates of unique markers to world coordinates is obtained. A previously computed homography transformation may be loaded from memory.

At block 708, a unique marker's position in an image is processed using the homography transformation to transform 2D image pixel coordinates to world coordinates. The unique marker is also decoded to obtain the marker's world coordinates (e.g., x, y, z) based on a predetermined layout of unique markers. An offset between the computed coordinates based on the transformed image coordinates and the expected predetermined world coordinates obtained from decoding the marker is determined. Offsets of a plurality of unique markers in a plurality of images may be determined in this way.

A mean offset and a maximum offset of the plurality of unique markers may be computed and compared to a threshold, at block 710. If the threshold is not exceeded, then the existing calibration is determined to be validated, at block 712. If one or both of the mean and maximum offsets exceeds the threshold, then the existing calibration is determined to not be validated, at block 714.

The method ends at block 716.

FIG. 8 shows an example of a method of performing a depth-based check on a calibration that may be used at block 618 in the method 600 of FIG. 6. The method starts at block 802.

The depth-based check checks 3D alignment between pairs of cameras using a relative 3D transformation between the cameras.

The method loops through pairs of cameras, via blocks 804 and 806, by selecting a next camera for consideration, at block 804. The pair of cameras may be physically adjacent cameras that are likely to capture similar groups of unique markers. A pair of cameras may be referred to as a first camera and a second camera. For example, a second camera may be physically adjacent a first camera, may be sufficiently close to the first camera (e.g., next to adjacent), or otherwise have an overlapping field of view with the first camera. The first camera may be aligned to the second camera, selected at block 806, as discussed below.

If Pose_1 and Pose_2 are calculated 4-by-4 pose matrices, such as a transformation matrix based on three position coordinates and three orientations values, for first camera and a second camera, respectively, then a 4-by-4 3D transformation from the first camera to the second camera may be expressed as:

Pose1_to_2=Pose_2*(Pose_1)⁻¹

The input for the depth-based check may include camera intrinsic parameters from N cameras, poses for N cameras, and 2D images and depth information for N cameras. With the known geometry and mapping between each camera's 2D image and depth information, a depth or real-world distance (e.g., Zi) of each detected unique marker may be determined. Then, each 2D feature of the first camera (e.g., xi, yi) is mapped to the first cameras 3D coordinate (e.g., Xi, Yi, Zi) through focal length (e.g., fx, fy) and principal point (e.g., cx, cy). The same deprojection from 2D pixel coordinate to 3D camera coordinate also applies to the second camera.

Via block 808, the method loops through common marker points found by both the first and second cameras and generates 3D coordinates for the first camera (e.g., Xi1, Yi1, Zi1) and the second camera (e.g., Xi2, Yi2, Zi2), respectively. Image coordinates (2D) of a common marker may be transformed to world coordinates (3D), at block 809, with reference to depth information and camera intrinsic properties 811. A transformation from the first camera to the second camera is computed with the transformation Pose1_to_2, above, at block 810, and a pose offset between the transformed 3D point of the first camera and the 3D point of the second camera is computed.

A mean pose offset for a plurality, such as all, common markers for a plurality, such as all, pairs of cameras may be computed, at block 812.

The method ends at block 814. The mean pose offset may be used to determine whether recalibration is to be performed, such as at block 620 in the method of FIG. 6.

FIG. 9 shows an example system 900. The system 900 is similar to the system 100 and only differences will be described in detail. The system 100 may be referenced for further description, with like reference numerals denoting like components.

The system 900 may include an arm 902 to secure a camera 104 to a platform that carries unique markers 120-127, so as to affix the camera 104 with respect to the unique markers 120-127. The system may further include a similar arm 904 for another camera 106.

The system 900 may further include a separate depth sensor 906 that is connected to the controller 108 to provide depth information.

The system 900 may further a user interface 908 connected to the controller 108 to receive and output user-interface feedback, as described elsewhere. The user interface may include a display, touchscreen, keyboard, and similar.

The system 900 may further include memory 910, such as a machine-readable medium, connected to the controller 108. The memory 910 may store executable instructions 912 to carry out functionality described here. The memory 910 may store relevant data 914, such as camera poses, calibration data, and the like.

In an example implementation, cameras are horizontally mounted and have a downward 20-degree angle with respect to the platform 110, which is in the horizontal plane. A working distance between a camera lens to surface of a target object is about 30 cm. In another example implementation, four depth sensors/cameras 906 and two imaging cameras 104, 106 are horizontally mounted and have a downward 30-degree angle with respect to the platform 110, which is in the horizontal plane. Two additional imaging cameras 104, 106 are vertically mounted and have a 45-degree angle with respect to the platform 110. The working distance of a camera lens may between 30 cm and 40 cm.

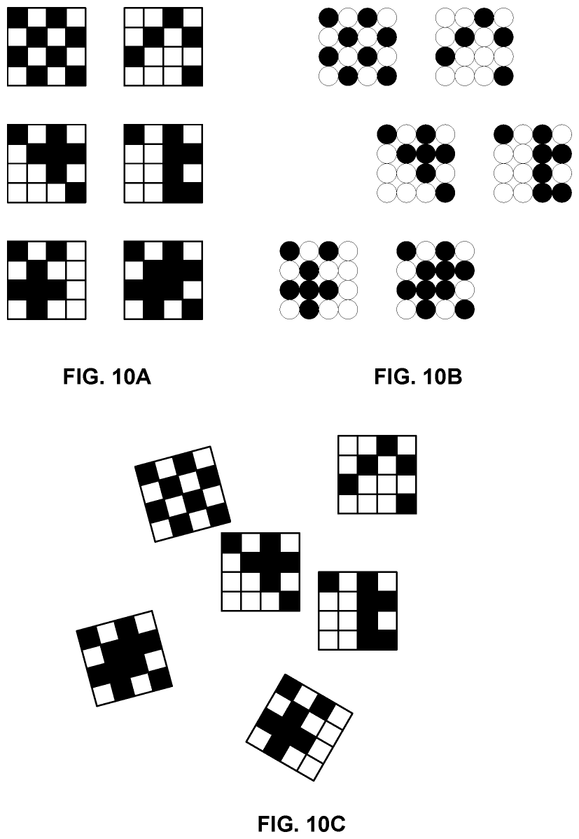

FIGS. 10A to 10C show example layouts for unique markers. The position and orientation of markers may be configured to meet a use case. Different types and shapes of markers may be used.

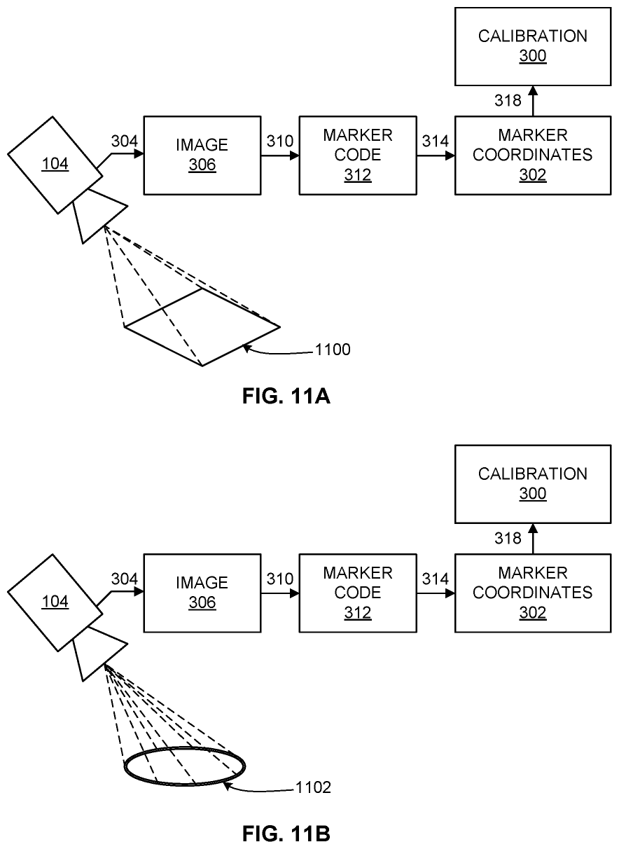

FIGS. 11A and 11B show an example camera 104 detecting unique markers of different shapes to generate a calibration 300. The description of FIG. 3 may be referenced for components not described here. Feature detection, contour detection, or similar technique may be used to detect unique markers in an image. Obtaining a calibration 300 is independent of marker type and shape and may be performed in conjunction with various marker detection methodologies.

For example, in FIG. 11A, a square or rectangular unique marker 1100 may appear as a polygon and may be detected using corner detection. In the example of FIG. 11B, a circular unique marker 1102 may appear as an ellipse and may be detected using contour detection.

It should be apparent from the above, that an accurate and robust pose calibration for 3D imaging systems is provided. A calibration may be performed without a separate calibration object or moving target. Unique markers may be arranged in various patterns to suit particular use cases. Further, poor imaging quality and obstructed markers may not significantly affect the calibration.

It should be recognized that features and aspects of the various examples provided above can be combined into further examples that also fall within the scope of the present disclosure. In addition, the figures are not to scale and may have size and shape exaggerated for illustrative purposes.

1. A system comprising:
a plurality of cameras to capture images of a target object;
a controller to connect to the plurality of cameras, the controller to control the plurality of cameras to capture the images of the target object, the controller further to determine a pose of a camera of the plurality of cameras; and
a platform to support the target object, the platform including a plurality of unique markers arranged in a predetermined layout;
wherein the controller is further to determine the pose of the camera based on unique markers of the plurality of unique markers that are detected in an image captured by the camera.

2. The system of claim 1, wherein the controller is further to:
check a pose offset of the camera with reference to a unique marker of the plurality of unique markers; and
redetermine the pose of the camera when the pose offset fails to meet an acceptable threshold.

3. The system of claim 1, wherein the controller is further to:
determine poses of the plurality of cameras from unique markers of the plurality of unique markers that are detected in images captured by the plurality of cameras.

4. The system of claim 3, wherein the controller is further to:
check a pose offset between the camera and another camera of the plurality of cameras; and
redetermine the poses of the plurality of cameras when the pose offset fails to meet an acceptable threshold.

5. The system of claim 3, wherein the controller is further to:
validate poses of the plurality of cameras from common unique markers of the plurality of unique markers that are detected in images captured by the plurality of cameras.

6. The system of claim 3, wherein the predetermined layout of the plurality of unique markers and a quantity of the plurality of unique markers are selected based on nominal poses of the plurality of cameras, wherein the quantity is greater than a minimum number of unique markers to determine the poses of the plurality of cameras.

7. The system of claim 1, wherein each unique marker of the plurality of unique markers is decodable to a unique code.

8. The system of claim 7, wherein each unique marker comprises areas of contrast in a detectable pattern.

9. The system of claim 1, wherein the controller is further to disregard a unique marker of the plurality of unique markers as detected in the image when the unique marker fails to meet a minimum imaging quality.

10. The system of claim 1, wherein the controller is further to count the unique markers detected in the image and to test that the count meets a minimum number of unique markers as a condition to determine the pose of the camera.

11. The system of claim 1, wherein the controller is further to test that imaging quality of the image meets a minimum imaging quality as a condition to determine the pose of the camera.

12. The system of claim 1, wherein the plurality of cameras is affixable to the platform, and wherein the platform is to be stationary with respect to the plurality of cameras during image capture.

13. A non-transitory machine-readable medium comprising:
instructions to control a plurality of cameras to capture images of a target object and determine poses of the plurality of cameras, wherein the poses are referenced to determine three-dimensional data of the target object from the images;
wherein the instructions are further to determine the poses based on unique markers that are detected in the images, the unique markers being arranged in a predetermined layout on a platform to support the target object; and
wherein the instructions are further to trigger user-interface feedback when a number of unique markers resolved in an image fails to meet a threshold number.

14. The non-transitory machine-readable medium of claim 13, wherein the instructions are further to determine a remedial user action for an unresolved unique marker in an image, and wherein the instructions are further to indicate the remedial user action in the user-interface feedback.

15. A system comprising:
a plurality of cameras to capture images;
a controller to connect to the plurality of cameras, the controller to control the plurality of cameras to capture the images; and
a platform including a plurality of unique markers arranged in a predetermined layout;
wherein the controller is to detect unique markers of the plurality of unique markers in an image captured by a camera of the plurality of cameras, rank detected unique markers based on imaging quality of the detected unique markers, and determine a pose of the camera using a selected number of ranked unique markers.
